(19) United States
(12) Patent Application Publication
(10) Pub. No.: US 2015/0228374 A1
(43) Pub. Date: Aug. 13, 2015

(54) THERMALLY CONDUCTIVE ELECTRONIC SUBSTRATES AND METHODS RELATING THERETO

(71) Applicant: E I DU PONT DE NEMOURS AND COMPANY, Wilmington, DE (US)

(72) Inventors: KERRY JOHN ADAMS, BRISTOL (GB); DAVID ANDREW GREENHILL, SOUTH GLOUCESTERSHIRE (GB); ALISTAIR GRAEME PRINCE, BRISTOL (GB); JOHN D. SUMMERS, CHAPEL HILL, NC (US)

(21) Appl. No.: 14/615,072

(22) Filed: Feb. 5, 2015

Related U.S. Application Data
(60) Provisional application No. 61/937,011, filed on Feb. 7, 2014.

(51) Int. Cl. H01B 3/30

(52) U.S. Cl. CPC H01B 3/306

(57) ABSTRACT

The present invention relates to polyimide pastes and methods of preparation. The polyimide pastes are used to prepare dielectric materials, and devices which include at least one layer which contain the polyimide pastes.

### FIELD OF INVENTION

The field of the invention relates to thermally conductive composite substrates for electronics applications which contain: i. At least one highly thermally conductive layer such as a metal (e.g. copper, aluminum) or a carbon based phase (e.g. pyrolytic graphite or graphene); and ii. At least one curable polyimide containing ink which may function as a dielectric, a conductor, a resistor, a capacitor, an encapsulant or a thermal via.

### TECHNICAL BACKGROUND OF THE INVENTION

Electronic packages and other similar substrates require low thermal impedances for some applications. This can be particularly true for applications that produce large amounts of heat, such as, high frequency HF wide band gap semiconductor devices (e.g. SiC or GaN based devices), high power electronics (e.g. rectifiers and the like), and high brightness light emitting diodes (HB-LED's). In such applications, conventional printed circuit boards (PCB's) are problematic due to their high thermal impedances and/or poor durability at elevated temperatures.

Current solutions to these thermal management issues include the use of insulated metal substrates (IMS), and metal core PCBs (MCPCBs). The conductor patterning process for MCPCB can be costly since it is a subtractive process involving numerous etching steps resulting in substantial material waste e.g. copper conductors. The curable polyimide inks of the present invention allow for additive deposition of functional electronic materials, for example using ink-jet or screen printing, of multiple layers directly onto the thermally conductive substrate surface in pre-defined circuit patterns, thereby significantly reducing time and material waste.

A means of further reducing the total thermal impedance of IMS and MCPCB mounted circuits often involves joining the boards to high mass heatsinks using thermal interface materials (TIMs) to help eliminate air entrapment at the interface. However, thermal interface materials themselves have inherent thermal resistance values (Rth) with typical associated thermal conductivities in the vicinity of 1-2 W/m·K. The polyimide inks of the present invention enable elimination of the TIM altogether by directly depositing the circuitry onto the heat sink surface, for example using ink-jet or screen-print deposition, thus reducing Rth of the substrate further.

A well-known approach for forming polyimide layers in situ onto various substrates is to imidize polyamic acid (PAA) at high temperatures (>350° C.) for prolonged periods of time (usually 2-3 hours). This approach has a number of performance disadvantages, most noticeably that the in situ imidization produces significant hydration products which can cause porosity in the cured film. In terms of dielectric breakdown voltage performance this has a significant deleterious effect. Furthermore, in order to dissolve PAA into an ink, aggressive dipolar aprotic solvents are required to dissolve it. These can include but are not limited to NMP (n-Methyl-2 pyrrolidone), DMAC (dimethylacetamide) which are both known reprotoxins, and BLO (butyrolactone).

The polyimide inks of the present invention rely upon a range of soluble polyimide resins that dissolve in a variety of more benign solvents; including but not limited to dibasic esters; lactamides; and acetates. Furthermore because the polyimide in this invention has already undergone imidization, there are no further hydration products generated during processing steps at elevated temperatures. This results in significant improvements in porosity and therefore resulting electromechanical properties. BDV per unit thickness values are higher than for PAA, as such thinner dielectric layers can be used with significantly reduces thermal impedance.

Other advantages offered by the polyimide inks of the present invention are the relatively low processing temperatures of 150° C. and above. These temperatures allow the use of the polyimide based inks on cast aluminum substrates without any danger of the cast substrate softening during the drying/curing of the polyimide inks. Furthermore, these low processing temperatures will also allow their use on copper substrates without the level of oxidation that would be expected at higher processing temperatures, such as those needed for the processing of PAA based inks.

Additionally, as the polyimide inks of the present invention can accommodate white particulate fillers whilst still maintaining acceptable BDV values at low coating thicknesses, they demonstrate reflective properties that cannot easily be achieved by the PAA based inks. This has great benefit when used in LED lighting applications.

U.S. Pat. No. 7,348,373 to Dueber, et al. is directed to screen printable polyimide compositions for embedded passives type electronic substrate applications.

### BRIEF DESCRIPTION OF THE FIGURES

FIGS. 1a and 1b are schematics of composite substrates build for electronic applications.

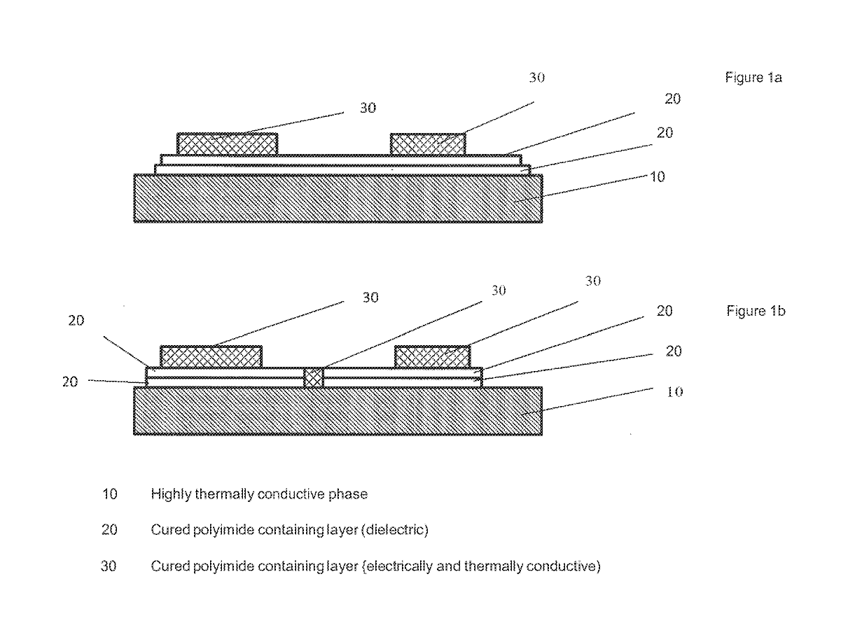

10: Highly thermally conductive layer
20: Curable polyimide containing dielectric layer
30: Electrically and thermally conductive polyimide layer

### SUMMARY OF THE INVENTION

The present invention is directed to a range of curable polyimide containing inks for electronic circuit manufacture, wherein the inks contain a polymer solution comprising a polyimide component and an organic solvent. The polyimide component is represented by formula I

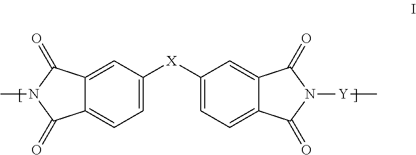

where X is C(CH3)2, O, S(O)2 or C(CF3)2, O-Ph-C(CH₃)₂-Ph-O, O-Ph-O— or a mixture of two, or more of C(CH3)2, O, S(O)2, and C(CF3)2; O-Ph-C(CH₃)₂-Ph-O, O-Ph-O—

where Y is a diamine component or mixture of diamine components selected from a group consisting of m-phenylenediamine (MPD), 3,4′-diaminodiphenyl ether (3,4′-ODA), 4,4′-diamino-2,2′-bis(trifluoromethyl)biphenyl (TFMB), 3,3′-diaminodiphenyl sulfone (3,3′-DDS), bis-(4-(4-aminophenoxyl)phenyl)sulfone (BAPS), 4,4′-(Hexafluoroisopropylidene)bis(2-aminophenol) (6F-AP) and 9,9-bis(4-aminophenyl)fluorene (FDA);

Additional diamines or “Y” components:

2,2-bis[4-(4-aminophenoxyphenyl)]propane (BAPP), 2,2-bis[4-(4-aminophenoxyphenyl)]hexafluoropropane (HFBAPP), 1,3-bis(3-aminophenoxy) benzene (APB-133), 2,2-bis(3-aminophenyl)hexafluoropropane, 2,2-bis(4-am inophenyl)hexafluoropropane (Bis-A-AF), 4,4′-bis(4-amino-2-trifluoromethylphenoxy) biphenyl, 4,4′-[1,3-phenylenebis(1-methyl-ethylidene)]bisaniline (Bisaniline-M)

provided however that:
a. if X is O, then Y is not m-phenylenediamine (MPD), bis-(4-(4-aminophenoxyl)phenyl)sulfone (BAPS) or 3,4′-diaminodiphenyl ether (3,4′-ODA); BAPP, APB-133, Bisaniline-M
b. if X is S(O)2, then Y is not 3,3′-diaminodiphenyl sulfone (3,3′-DDS); and
c. if X is C(CF3)2, then Y is not m-phenylenediamine (MPD), bis-(4-(4-aminophenoxyl)phenyl)sulfone (BAPS), 9,9-bis(4-aminophenyl)fluorene (FDA), or 3,3′-diaminodiphenyl sulfone (3,3′-DDS).
d. If X is O-Ph-C(CH₃)2-Ph-O or O-Ph-O—, then Y is not m-phenylene diamine (MPD), FDA, 3,4′-ODA, BAPP, APB-133, bisaniline-M.

Solvents known to be useful in accordance with the present invention include organic liquids having both: (i.) a Hanson polar solubility parameter between and including any two of the following numbers 2.5, 3.0, 4.0, 5.0, 6.0, 7.0, 8.0, 9.0, and 10.0, provided the polyimide is sufficiently soluble in the solvent to form an acceptable paste, depending upon the particular end use application chosen; and (ii.) a normal boiling point between and including any two of the following numbers 180, 190, 200, 210, 220, 230, 240 and 250° C.

The polyimide and solvent are combined into a paste by the application of agitation and optional heating. The word “paste” is intended to include solutions, suspensions or otherwise a homogeneous or non-homogeneous blending of the two materials. In one embodiment, the polyimide paste can be combined with a thermal cross-linking agent, or the polyimide component can further comprise a crosslink site (by incorporation of a crosslink monomer) in the polyimide backbone. In some embodiments of the present invention, it may be useful for the polyimide paste to further comprise a blocked isocyanate, an adhesion promoter, and/or inorganic fillers, including metals or metal oxides. In instances where the paste contains additional particulate components, these are dispersed by a variety of techniques (e.g. mixing, high shear dispersion or three roll milling).

As used herein, the term “metal oxide” is defined as a mixture of one or more metals with an element of Groups IIIA, IVA, VA, VIA or VIIA. In particular, the term metal oxides also includes, metal carbides, metal nitrides, and metal borides.

The compositions of the present invention can generally be used in electronic circuitry type applications. In particular, the compositions can generally be used to produce electronic components such as dielectrics, resistors, discrete or planar capacitors, inductors, encapsulants, conductive adhesives, electrical and thermal conductors.

### DETAILED DESCRIPTION OF THE PREFERRED EMBODIMENTS

In one embodiment, the present invention is directed toward polyimide pastes that are used to prepare dielectric materials. The dielectric paste compositions of the present invention can be applied to a wide variety of substrate materials to form a dielectric layer. One type of electronic device would be the printing of one or more dielectric layers onto a suitable metallic heatsink with one or more flat surfaces suitable for the deposition of the dielectric by screen printing, or other suitable laydown technique. The subsequent printing of a conductor layer or layers onto the dielectric would then facilitate the attachment of electronic components, for example LED's, by a variety of attachment techniques, for example soldering or the use of conductive adhesives.

In one embodiment of the present invention, a polymer thick film (PTF) resistor composition is made from a screen-printable resistor paste composition of the present invention. The resistor paste composition is derived from a polyimide paste and an electrically conductive material (e.g. carbon in the form of a fine powder).

In one embodiment, the present invention is directed towards polyimide pastes that are used to prepare electrically and thermally conductive materials. The conductive paste composition is derived from a polyimide paste and an electrically conductive material (e.g. a metal or combination of metals in the form of fine powders).

In another embodiment, the electrically and thermally conductive materials are solderable and/or wire bondable.

In a further embodiment, the electrically and thermally conductive materials can be used as thermal vias or plugs.

In a further embodiment of the present invention is directed towards polyimide pastes that are used to prepare capacitative materials. The capacitative paste is derived from a polyimide paste and a suitable filler (e.g. barium titanate).

In yet another embodiment, the polyimide can be used as an encapsulant. The encapsulant composition is derived from a polyimide paste and the inclusion of an optional filler (for example a pigment or dye).

In one embodiment, the solvent is a dibasic ester or blend thereof, i.e., an ester of a dicarboxylic acid (examples of which include, but are not limited to, adipic acid, glutaric acid and succinic acid), where the alcohol (which reacts with the dicarboxylic acid to for the dibasic ester) can be methanol or higher molecular weight monoalcohols. Useful dibasic ester solvents, include dibasic ester phthalates, adipates, and azelates with a variety of alcohols. In addition, a range of acetate solvents have also been found to provide sufficient solubility of the polyimide resins when used in conjunction with one or more other solvents described here.

Other useful solvents are represented by any one, or any combination of formulas II, III and/or IV.

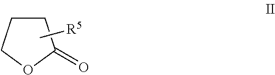

where R5 is H, CH3, or CH3CH2

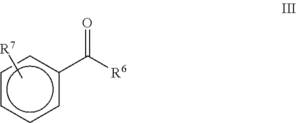

where R6 is H, CH3, CH3CH2, or OCH3 and wherein R7 is H, CH3, or CH3CH2 and

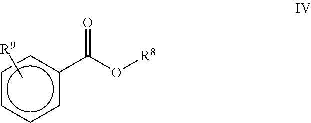

where R8 is CH3, or CH3CH2 and wherein R9 is H, CH3, or CH3CH2.

In one embodiment of the present invention, the polyimides have cross-linkable sites. The crosslinkable sites can be provided by preparing the polyimide in the presence of a second diamine, preferably, a second diamine containing one or more phenol groups. One preferred cross-linkable diamine is 3,3′-dihydroxy-4,4′-diaminobiphenyl (HAB).

Other diamines that are cross-linkable are selected from the following group 2,4-diaminophenol, 2,3-diaminophenol, 3,3′-diamino-4,4′-dihydroxy-biphenyl, and 2,2′-bis(3-amino-4-hydroxyphenyl)hexafluoropropane. For purposes of the present invention, a cross-linkable diamine may be used as a part of the total diamine component ranging from 0, 2, 4, 6, 10, 15, 20, 25, and up to and including 30 mole percent.

The polyimides of the invention are prepared by reacting one or more of the dianhydrides (or the corresponding diacid-diester, diacid halide ester, or tetracarboxylic acid thereof) with one or more diamines. The mole ratio of dianhydride to diamine is preferably from 0.9 to 1.1. Most preferably, a slight molar excess of dianhydrides is used to give a mole ratio of about 1.01 to 1.02.

The polyimides of the present invention can be made by thermal and chemical imidization using a different solvent as otherwise described herein. The polyimide can be dried of the solvent then re-dissolved in a solvent disclosed herein. Using a thermal method, the dianhydride can be added to a solution of the diamine in any of the following polar solvents, m-cresol, 2-pyrrolidone, N-methylpyrrolidone (NMP), N-ethylpyrrolidone, N-vinylpyrrolidone, N,N-dimethylacetamide (DMAc), N,N-dimethylformamide (DMF) and γ-butyrolactone (BLO). The reaction temperature for preparation of the polyamic acid or polyamic acid ester is typically between 25° C. and 40° C. Alternatively, the dianhydrides were dissolved in one of these solvents, and the diamines were added to the dianhydride solution.

After the polyamic acid (or polyamic acid ester) is produced, the temperature of the reaction solution is then raised considerably to complete the dehydration ring closure. The temperatures used to complete the ring closure are typically from 150° C. to 200° C. A high temperature is used is to assure converting the polyamic acid into a polyimide.

The chemical method includes the use of a chemical imidizing agent, which is used to catalyze the dehydration, or ring closing. Chemical imidization agents such as acetic anhydride and 3-picoline can be used. The reaction solvent is not particularly limited so long as it is capable of dissolving the obtained polyimide. The resulting polyimide is then precipitated by adding the polyimide solution to a precipitation solvent such as methanol, ethanol, or water. The solid is washed several times with the solvent, and the precipitate is oven dried. Once dried, the isolated resin can then be dissolved in a variety of suitable solvents previously described.

These polyimide pastes can be combined with other materials to produce pastes for screen printable applications in electronic circuitry applications. Some polyimides of the invention that are sufficiently soluble in suitable screen printing solvents are listed in the EXAMPLES below.

Another advantage to using the solvents disclosed in the present invention is that in certain embodiments, very little, if any, precipitation of the polyimide is observed when handling a paste composition. Also, the use of a polyamic acid solution may be avoided. Instead of using a polyamic acid, which can be thermally imidized to the polyimide later during processing, an already formed polyimide is used. This allows for lower curing temperatures to be used, temperatures not necessary to convert, to near completion, a polyamic acid to a polyimide. In short, the resulting solutions can be directly incorporated into a liquid or paste composition for coating and screen printing applications without having to cure the polyimide.

Most thick film compositions are applied to a substrate by screen printing, stencil printing, dispensing, doctor-blading into photoimaged or otherwise preformed patterns, or other techniques known to those skilled in the art. These compositions can also be formed by any of the other techniques used in the composites industry including pressing, lamination, extrusion, molding, and the like. However, most thick film compositions are applied to a substrate by means of screen-printing. Therefore, they must have appropriate viscosity so that they can be passed through the screen readily. In addition, they should be thixotropic in order that they set up rapidly after being screened, thereby giving good resolution. Although the rheological properties are of importance, the organic solvent should also provide appropriate wettability of the solids and the substrate, a good drying rate, and film strength sufficient to withstand rough handling.

Curing of the final paste composition is accomplished by any number of standard curing methods including convection heating, forced air convection heating, vapor phase condensation heating, conduction heating, infrared heating, induction heating, or other techniques known to those skilled in the art.

In some applications the use of a crosslinkable polyimide in a liquid or paste composition can provide important performance advantages over the corresponding non-crosslinkable polyimides of the invention. For example, the ability of the polyimide to crosslink with crosslinking agents during a thermal cure can provide electronic coatings with enhanced thermal and humidity resistance. The resulting cross-linked polyimide can stabilize the binder matrix, raise the Tg, increase chemical resistance, or increase thermal stability of the cured coating compositions. Compared to polyimides that contain no crosslinking functionality, slightly lower Tg of the polyimide or slightly higher moisture absorption of the polyimide can be tolerated.

In another embodiment of the present invention, a thermal crosslinking agent is added to the polyimide formulation (typically a polyimide solution) to provide additional crosslinking functionality. A highly cross-linked polymer, after a thermal curing cycle, can yield electronic coatings with enhanced thermal and humidity resistance. The effect of thermal crosslinking agent is to stabilize the binder matrix, raise the Tg of the binder, increase chemical resistance, and increase thermal resistance of the cured, final coating composition.

Preferable thermal crosslinkers useful in the present invention include (1) epoxy resins, which can react with the phenolic functionality in the crosslinkable polyimide; (2) blocked isocyanates that can react with hydroxyls including those resulting from the epoxy-crosslinkable polyimide reaction; and (3) polyhydroxystyrene which can react with the epoxy functionality in the epoxy-containing resin.

Other preferred thermal crosslinking agents are selected from the group consisting of bisphenol epoxy resin, an epoxidized copolymer of phenol and aromatic hydrocarbon, a polymer of epichlorohydrin and phenol formaldehyde, and 1,1,1-tris(p-hydroxyphenyl)ethane triglycidyl ether.

The liquid or paste compositions of the present invention can also further include a hydroxyl-capping agent. A hydroxyl-capping agent is believed to provide additional solution stability. A blocked isocyanate agent can be used as a hydroxyl-capping agent.

The different coating compositions for electronic coating applications require different functional fillers that allow the required electrical, thermal or insulator property to be obtained. Functional fillers for dielectrics, resistors and electrical conductors include, but are not limited to, one or more metals or metal oxides (e.g., ruthenium oxides and the other resistor materials described in U.S. Pat. No. 4,814,107, the entire disclosure of which is incorporated herein by reference.)

As used herein, the term “metal oxide” is defined as a mixture of one or more metals with an element of Groups IIIA, IVA, VA, VIA or VIIA. In particular, the term metal oxides also includes, metal carbides, metal nitrides, and metal borides.

Functional fillers for capacitors include, but are not limited to, barium titanate, lead magnesium niobate, and titanium oxide. Functional fillers for encapsulants include, but are not limited to, fumed silica, alumina, and titanium dioxide. Encapsulant compositions can be unfilled, with only the organic binder system used, which has the advantage of providing transparent coatings for better inspection of the encapsulated component. Functional fillers for thermally conductive coatings include, but are not limited to barium nitride, aluminum nitride, boron nitride, aluminum oxide, graphite, beryllium oxide, silver, copper, and diamond.

PTF materials have received wide acceptance in commercial products, notably for flexible membrane switches, touch keyboards, automotive parts and telecommunications. These compositions contain filler material dispersed with the polyimides of the invention. The compositions can be processed at relatively low temperatures, namely the temperatures needed to remove the solvents in the composition and cure the polyimide binder system, for crosslinkable polyimide compositions. The actual resistivity/conductivity required for the resulting pastes will vary depending on the electronic application.

The liquid or paste compositions of the present invention can further include one or more metal adhesion agents. Preferred metal adhesion agents are selected from the group consisting of polyhydroxyphenylether, polybenzimidazole, polyetherimide, and polyamideimide. Typically, these metal adhesion agents are dissolved in the polyimide solutions of the present invention.

The polyimides of the invention can also be dissolved into a solution and used in IC and wafer-level packaging as semiconductor stress buffers, interconnect dielectrics, protective overcoats (e.g., scratch protection, passivation, etch mask, etc.), bond pad redistribution, alignment layers for a liquid crystal display, and solder bump under fills. One advantage of the pre-imidized materials of the present invention (versus a polyamic acid-type paste) is the lower curing temperature needed in downstream processing. Current packaging requires a cure temperature of about 300° C.+/−25° C.

The advantages of the materials of the present invention are illustrated in the following EXAMPLES.

### EXAMPLES

### Glossary of Terms

The following glossary contains a list of names and abbreviations for each ingredient used:

Chemicals and abbreviations

| | |
|---|---|
| 3,4′-ODA | 3,4′-diaminodiphenyl ether |
| TFMB | 4,4′-diamino-2,2′-bis(trifluoromethyl)biphenyl |
| 6F-AP | 4,4′-(Hexafluoroisopropylidene)bis(2-aminophenol) |
| BAPP | 2,2-Bis [4-(4-aminophenoxy)phenyl] propane |
| 6FDA | 4,4′-(Hexafluoroisopropylidene) bis-phthalic anhydride |
| BPADA | 4,4′-Bisphenol A dianhydride |
| DSDA | 3,3′,4,4′-Diphenylsulfone tetracarboxylic dianhydride |
| BDV | Breakdown Voltage |

### Manufacture of Pastes

Pastes consisting solely of polyimide and solvent were prepared by dissolving the polyimide into one or more solvents in a glass reaction flask with stirring and the application of heat, usually in the range of 60-80° C.

Pastes that contained particulate fillers and optional extra additives, such as crosslinkers, surfactants and catalysts, were made by high shear processing. The ingredients were first mixed under low shear using a small mixer. The mixed paste was then further processed on a three roll mill to increase the level of dispersion and yield a mixed and homogenous paste.

### Screen Printing

In order to test the performance of the polyimide pastes, they first need to be used to create suitable test parts. This was achieved with screen printing using an MPM printer. The substrates used were aluminum substrates of various grades, typically cut into 50 mm×50 mm parts. After deburring and cleaning, the substrates were used in the preparation of the various test parts. In order to create the required test pattern architecture, various stainless steel screens were used in the preparation of the test parts. The dielectric layers were typically applied using a double wet pass print. Each layer was dried, typically at 150 for 30 minutes prior to the printing of any subsequent dielectric layers. When all of the dielectric layers were printed and dried, an additional cure regime was adopted in the case of pastes with thermal crosslinkers present. Typically this would be 1 hour at 200° C. In all cases, the drying and curing was carried out in box ovens. The thermally and conductive layers were then printed onto the now prepared dielectric layers. After printing, these subsequent layers were typically dried at 200° C. for one hour.

### BDV Testing

The prepared parts for BDV testing were measured using a EuroDidact HT6000 direct current BDV tester. Typically, a total of five separate substrates, with three different conductor pads on each, were tested to yield a total of fifteen values.

### Conductivity Measurements

The prepared parts for conductivity measurements were measured using a Keithley 2000 multimeter using a four wire setup for the test probes. Typically ten individual test parts would be measured, to yield an average of ten measurements.

### Thickness Measurements

The thickness values of the test parts prepared for conductivity measurement were measured on a Taylor Hobson Talysurf series 2 profilometer. Typically, the pattern used in conductivity measurements was a serpentine, and a total of ten or more thickness measurements could be obtained from each test part. The overall average thickness was then used to normalize the resistance measurements.

### Example 1

### 6FDA//TFMB/6F-AP Copolymer, 15 Mole % 6F-AP, Thermal Imidization

A polyimide was prepared by conversion of a polyamic acid to polyimide with thermal imidization. To a dry three neck round bottom flask equipped with nitrogen inlet, mechanical stirrer and condenser was added 800.23 grams of NMP, 70.31 grams of 3,3′-bis-(trifluoromethyl)benzidine (TFMB), 14.18 grams 2,2′-bis(3-amino-4-hydroxyphenyl)hexafluoropropane (6F-AP) and 0.767 grams of phthalic anhydride.

To this stirred solution was added over one hour 113.59 grams of 2,2′-bis-3,4-dicarboxyphenyl)hexafluoropropane dianhydride (6-FDA). The solution of polyamic acid reached a temperature of 31° C. and was stirred without heating for 16 hrs. Aromatic 150 solvent, 100 g, was then added to the poly(amic acid) solution. The flask was fitted with a Dean Stark Trap and the poly(amic acid) solution was then heated to the refluxing temperature of Aromatic 150, approximately 158° C. The refluxing Aromatic 150 removed the water of imidization from the reaction as an azeotrope, the water was collected in the Dean Stark Trap. The imidization reaction was allowed to proceed for twelve hours.

The solution was then cooled to room temperature, and the solution added to an excess of methanol in a blender to precipitate the product polyimide. The solid was collected by filtration and was washed 2 times by re-blending the solid in methanol. The product was dried in a vacuum oven with a nitrogen purge at 150° C. for 16 hrs to yield 135.2 grams of product having a number average molecular weight of 48,200 and a weight average molecular weight of 134,700.

In a similar manner, polymers containing five mole %, ten mole % and zero mole % 6F-AP were prepared.

### Example 2

### 6FDA//TFMB/6F-AP Copolymer, 15 Mole % 6F-AP, Chemical Imidization

A polyimide was prepared by conversion of a polyamic acid to polyimide with chemical imidization. To a dry three neck round bottom flask equipped with nitrogen inlet, mechanical stirrer and condenser was added 800.23 grams of DMAC, 70.31 grams of 3,3′-bis-(trifluoromethyl)benzidine (TFMB), 14.18 grams 2,2′-bis(3-amino-4-hydroxyphenyl)hexafluoropropane (6F-AP) and 0.767 grams of phthalic anhydride.

To this stirred solution was added over one hour 113.59 grams of 2,2′-bis-3,4-dicarboxyphenyl)hexafluoropropane dianhydride (6-FDA). The solution of polyamic acid reached a temperature of 32° C. and was stirred without heating for 16 hrs. To 104.42 grams of acetic anhydride were added followed by 95.26 grams of 3-picoline and the solution was heated to 80° C. for 1 hour.

The solution was cooled to room temperature, and the solution added to an excess of methanol in a blender to precipitate the product polyimide. The solid was collected by filtration and was washed 2 times by re-blending the solid in methanol. The product was dried in a vacuum oven with a nitrogen purge at 150° C. for 16 hrs to yield 165.6 grams of product having a number average molecular weight of 54,600 and a weight average molecular weight of 151,400.

### Example 3

The polymers prepared according to Example 1 were crosslinked using the following procedure. The polyimide, 8 g, was dissolved in 32 g DBE-3. The epoxy resin RSS-1407, 0.75 g, was then added to this solution and dissolved by stirring. Dimethylbenzylamine catalyst, 0.1 g, was then added with stirring. A portion of the solution was cast on a glass plate using a casting bar and cured at 170° C. for 1 hour, followed by 230° C. for two minutes in a forced air convection oven. The resulting film was no longer soluble in NMP. By comparison, the polyimide prepared according to Example 2 without the 6F-AP co-monomer exhibited solubility in NMP, and the polyimides prepared with five mole % and ten mole % 6F-AP exhibited swelling behavior in NMP but did not dissolve.

### Example 4

The polymer prepared according to example 2 with 15 mole % 6F-AP was converted into a screen printable dielectric ink in the following way.

Firstly, a 27% weight percent solution was made by adding the polymer to a heated, stirred mixture of diethyl adipate, butyl carbitol acetate and DBE-3 dibasic ester in the approximate ratio of 3:3:1. After heating to between 60-70° C. for a period of 8 hours, a clear, slightly viscous solution was obtained.

This polyimide solution was then combined with a boron nitride filler (D₅₀˜2 microns), surfactant, epoxy crosslinker and catalyst along with additional solvent to yield a viscosity of approximately 100 Pa·s at 10 rpm after mixing, triple roll milling and screening.

The composition was as follows:

| Ingredient | Ink A (wt. %) |
|---|---|
| Polyimide solution polymer | 66.0 |
| Epoxy crosslinker | 3.3 |
| Catalyst | 0.1 |
| Surfactant | 1.0 |
| Boron Nitride | 21.7 |
| Butyl carbitol acetate | 7.9 |

The above ink was subsequently screen printed onto an aluminium substrate to yield a dielectric thickness in the range of 20-25 microns after the printing of two separate layers. The first layer was dried at 150° C. for 30 minutes before the second layer was printed. The second layer, after printing, was dried also at 150° C. for 30 minutes. The whole printed assembly was subsequently cured at 200° C. for a further 60 minutes prior to the printing of a top conductor.

The top conductor consisted of a screen printable ink with approximately 69 weight percent silver (D₅₀˜1-2 microns) dispersed in a low tg polyester solution polymer. The conductor was printed as a single layer, and dried at 200° C. for 60 minutes.

The test parts produced in the method described above were then placed into a thermal cycling chamber which was programmed to cycle between −40° C. and +125° C. Parts were removed after 250, 500 and 1000 cycles for BDV measurements. In addition, a series of parts were also measured prior to any thermal cycling to provide a control sample. In each case a total of fifteen BDV values were obtained after 0, 250, 500 and 1000 cycles. The values obtained are shown below.

| Number of thermal | Mean BDV | Maximum BDV | Minimum BDV |
|---|---|---|---|
| cycles | (kV) | (kV) | (kV) |
| 0 | 3.88 | 4.78 | 2.17 |
| 250 | 3.78 | 4.45 | 3.09 |
| 500 | 3.50 | 4.51 | 2.66 |
| 1000 | 4.07 | 5.12 | 2.12 |

The polymer prepared according to example 2 with 15 mole % 6F-AP was converted into a screen printable silver ink in the following way.

Firstly, a 27% weight percent solution was made by adding the polymer to a heated, stirred mixture of diethyl adipate, butyl carbitol acetate and DBE-3 dibasic ester in the approximate ratio of 3:3:1. After heating to between 60-70° C. for a period of 8 hours, a clear, slightly viscous solution was obtained.

This polyimide solution was then combined with a silver powder (Surface Area ˜2 m²/g) at various concentrations. After mixing and triple roll milling, the inks were diluted with a suitable solvent to obtain inks with viscosities in the range of 200-300 Pa·s at 10 rpm. The compositions produced were as follows:

| | Ink B | Ink C | Ink D |
|---|---|---|---|
| | (wt. %) | (wt. %) | (wt. %) |
| Silver | 74.8 | 79.1 | 82.2 |
| Polyimide solution polymer | 18.9 | 13.9 | 9.1 |
| Butyl carbitol acetate | 8.3 | 7.0 | 8.7 |

These samples were then screen printed onto alumina substrates in a 1000 square serpentine pattern in order to measure the resistivity and hence calculate the resistivity at a normalized thickness. The printed parts were dried at 150° C. for 30 minutes followed by a second drying time of 60 minutes at 200° C. After drying, the thickness and resistance characteristics were subsequently measured. The results obtained are shown below.

| | Mean | Mean | Mean resistivity |
|---|---|---|---|
| Ink | resistance | thickness | (m□ per square |
| Lot | (□) | (□m) | at 25 □m) |
| B | 10.7 | 26.9 | 11.5 |
| C | 3.8 | 34.7 | 5.3 |
| D | 2.3 | 43.5 | 4.1 |

### Example 6

The polymer prepared according to example 2 with 15 mole % 6F-AP was converted into a screen printable dielectric ink in the following way.

Firstly, a 27% weight percent solution was made by adding the polymer to a heated, stirred mixture of diethyl adipate, butyl carbitol acetate and DBE-3 dibasic ester in the approximate ratio of 3:3:1. After heating to between 60-70° C. for a period of 8 hours, a clear, slightly viscous solution was obtained.

This polyimide solution was then combined with a aluminum nitride filler (PSD info), titanium dioxide filler (PSD info), surfactant, epoxy crosslinker and catalyst along with additional solvent to yield a viscosity of approximately 100 Pa·s at 10 rpm after mixing, triple roll milling and screening.

The compositions made were as follows:

| | Ink E | Ink F | Ink G | Ink H |
|---|---|---|---|---|
| Ingredient | (wt. %) | (wt. %) | (wt. %) | (wt. %) |
| Polyimide solution polymer | 67.20 | 66.51 | 65.18 | 63.90 |
| Epoxy crosslinker | 0.00 | 0.67 | 1.96 | 3.20 |
| Catalyst | 0.00 | 0.02 | 0.06 | 0.10 |
| Surfactant | 1.00 | 1.00 | 1.00 | 1.00 |
| Aluminium Nitride | 16.00 | 16.00 | 16.00 | 16.00 |
| Titanium Dioxide | 8.00 | 8.00 | 8.00 | 8.00 |
| Butyl carbitol acetate | 7.80 | 7.80 | 7.80 | 7.80 |

The above inks were subsequently screen printed onto a number of aluminium substrates. In this instance, only single layer prints were produced. The samples were dried at 150° C. for a period of 30 minutes. These parts were then subsequently cured at temperatures in the range of 150-275° C. for a period of 60 minutes. The dried and cured parts were then immersed in a mixture of solvents (diethyl adipate, butyl carbitol acetate and DBE-3 dibasic ester in the approximate ratio of 3:3:1) for a period of one week to assess the level of crosslinking in each of the inks as a function of curing temperature. The results obtained are as follows.

| | Ink E | Ink F | Ink G | Ink H |
|---|---|---|---|---|
| 150° C. Cure 60 minutes | 1 | 1 | 1 | 3 |
| 200° C. Cure 60 minutes | 1 | 2 | 2 | 3 |
| 250° C. Cure 60 minutes | 2 | 2 | 3 | 3 |
| 275° C. Cure 60 minutes | 2 | 3 | 3 | 3 |

1 - Printed and cured layer dissolved during solvent immersion test.
2 - Printed and cured layer was partially dissolved during solvent immersion test.
3 - Printed and cured layer was intact after solvent immersion test.

What is claimed is:

1. A thermally conductive composite electronic substrate, comprising:
a. a thermally conductive layer comprising metal, graphite or other material having a thermal conductivity of greater than 2, 5, 10, 15, 20, 25, 50, 100, 250, 500 or 1000 Watts/(meter·degree Kelvin); and
b. a dielectric layer in direct contact with the thermally conductive layer, having a thickness of no more than 100, 50, 30, 25, 20, 15, 12, or 10 microns, the dielectric layer comprising a polyimide represented by formula I: 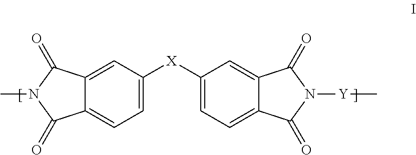
c. optionally, a thermally and electrically conductive layer in direct contact with the dielectric layer, with the thermally and electrically conducting layer comprising a polyimide represented by the formula I and additional thermally and electrically conductive fillers.
wherein X is C(CH3)2, O, S(O)2 or C(CF3)2, O-Ph-C(CH₃)₂-Ph-O, O-Ph-O— or a mixture of two, or more of C(CH3)2, O, S(O)2, and C(CF3)2, O-Ph-C(CH₃)₂-Ph-O, O-Ph-O—;
wherein Y is diamine component or mixture of diamine components selected from the group consisting of:
m-phenylenediamine (MPD),
3,4′-diaminodiphenyl ether (3,4′-ODA),
4,4′-diamino-2,2′-bis(trifluoromethyl)biphenyl (TFMB),
3,3′-diaminodiphenyl sulfone (3,3′-DDS),
4,4′-(Hexafluoroisopropylidene)bis(2-aminophenol) (6F-AP)
bis-(4-(4-aminophenoxyl)phenyl)sulfone (BAPS) and
9,9-bis(4-aminophenyl)fluorene (FDA);
2,3,5,6-tetramethyl-1,4-phenylenediamine (DAM), 2,2-bis[4-(4-aminophenoxyphenyl)]propane (BAPP), 2,2-bis[4-(4-aminophenoxyphenyl)]hexafluoropropane (HFBAPP), 1,3-bis(3-aminophenoxy) benzene (APB-133), 2,2-bis(3-aminophenyl)hexafluoropropane, 2,2-bis(4-aminophenyl)hexafluoropropane (Bis-A-AF), 4,4′-bis(4-amino-2-trifluoromethylphenoxy) biphenyl, 4,4′-[1,3-phenylenebis(1-methyl-ethylidene)]bisaniline (Bisaniline-M)
with the proviso that:
i. if X is O, then Y is not m-phenylenediamine (MPD), bis-(4-(4-aminophenoxyl)phenyl)sulfone (BAPS) and 3,4′-diaminodiphenyl ether (3,4′-ODA); BAPP, APB-133, Bisaniline-M
ii. if X is S(O)₂, then Y is not 3,3′-diaminodiphenyl sulfone (3,3′-DDS);
iii. if X is C(CF₃)₂, then Y is not m-phenylenediamine (MPD), bis-(4-(4-aminophenoxyl)phenyl)sulfone (BAPS), 9,9-bis(4-aminophenyl)fluorene (FDA), and 3,3′-diaminodiphenyl sulfone (3,3′-DDS);
iv. if X is O-Ph-C(CH₃)₂-Ph-O or O-Ph-O—, then Y is not m-phenylene diamine (MPD), FDA, 3,4′-ODA, DAM, BAPP, APB-133, bisaniline-M

2. A composite substrate according to claim 1, wherein the polyimide is derived from a diamine component where from 0.1 to 30 mole percent of the diamine component is selected from the group consisting of 3,3′-dihydroxy-4,4′-diaminobiphenyl (HAB), 2,4-diaminophenol, 2,3-diaminophenol, 3,3′-diamino-4,4′-dihydroxy-biphenyl, and 2,2′-bis(3-amino-4-hydroxyphenyl)hexafluoropropane.

3. A composite substrate according to claim 1, wherein the polyimide comprises or is partially derived from a thermal crosslinking agent.

4. A composite substrate according to claim 3, wherein the thermal crosslinking agent is selected from the group consisting of:
a bisphenol epoxy resin,
an epoxidized copolymer of phenol and aromatic hydrocarbon,
a polymer of epichlorohydrin and phenol formaldehyde, and
1,1,1-tris(p-hydroxyphenyl)ethane triglycidyl ether.

5. A composite substrate according to claim 1, wherein the polyimide comprises or is partially derived from a blocked isocyanate.

6. A composite substrate according to claim 1, further comprising a metal adhesion agent selected from the group consisting of polyhydroxyphenylether (PKHH), polybenzimidazole, and polyamideimide.

7. A composite substrate according to claim 1, further comprising a dielectric layer containing a thermally conductive filler.

8. A composite substrate according to claim 7, wherein the thermally conductive filler comprises a metal, a carbide, a nitride, an oxide or an allotropic form of carbon.

9. A composite substrate according to claim 8, wherein the thermally conductive filler has at least one dimension that is less than 100 nanometers.

10. A composite substrate according to claim 1, wherein the thermally and electrically conductive layer is solderable.

11. A composite substrate according to claim 1, wherein the thermally and electrically conductive layer is wire bondable.

12. A composite substrate according to claim 1, wherein the thermally and electrically conductive layer is in direct with the dielectric layer and the underlying thermally conducting layer, thus creating a thermal via or plug.
